(19) United States
(12) Patent Application Publication
(10) Pub. No.: US 2017/0011482 A1
(43) Pub. Date: Jan. 12, 2017

(54) LICENSE NUMBER MANAGEMENT SYSTEM AND LICENSE NUMBER MANAGEMENT METHOD

(71) Applicant: FUJITSU LIMITED, Kawasaki-shi (JP)

(72) Inventors: Hiroyuki Shimoda, Nagano (JP); Takashi Usuyama, Itabashi (JP); Hidekazu Tsukada, Nagano (JP); Akira Ooike, Nagano (JP); Naoyuki Kitazawa, Nagano (JP)

(21) Appl. No.: 15/187,525

(22) Filed: Jun. 20, 2016

(30) Foreign Application Priority Data
Jul. 7, 2015 (JP) 2015-136149

(51) Int. Cl. G06Q 50/18

(52) U.S. Cl. CPC G06Q 50/184; G06Q 2220/18

(57) ABSTRACT

A license number management system performs a login process according to first authentication or second authentication. The first authentication is performed for allowing usage of a service in both an online and offline status, and the second authentication is performed for allowing usage of the service only in the online status. In a case of authenticating a terminal according to the first authentication, license management information is updated to a used state when data needed for using the service is transmitted to the terminal, and the license management information is updated to a not used state when the data is received from the terminal. In a case of authenticating the terminal according to the second authentication, the license management information is updated to a used state when the terminal is successfully authenticated and the license management information is updated to a not used state when the terminal logs out.

### CROSS-REFERENCE TO RELATED APPLICATION

This patent application is based upon and claims the benefit of priority of the prior Japanese Patent Application No. 2015-136149 filed on Jul. 7, 2015, the entire contents of which are incorporated herein by reference.

### FIELD

The embodiments discussed herein are related to a license number management system and a license number management method.

### BACKGROUND

Applications (application programs) are generally used in the form of permitting usage of a license, and there are various modes such as a CPU license, a user license, a concurrent license, etc.

With respect to an application that is used for a particular purpose in a company, etc., the users and terminals executing the application are often indefinite, and therefore a license that specifies the user and terminal is not suitable. A concurrent license, which specifies the upper limit of the number of users that are allowed to simultaneously use the license, does not limit particular users or terminals, and is considered to be economic in terms of the relationship between the benefits of using the application and the counter value. Furthermore, when equipment such as a server, etc., is involved when executing the application, it is convenient that the upper limit of the number of users that are allowed to simultaneously use the license is fixed, from the viewpoint of appropriately maintaining the load of the server, etc.

Due to the above reasons, with respect to an application that is used for a particular purpose in a company, etc., a concurrent license is often used. Note that management of a concurrent license is generally performed by confirming the activation and the termination of the application by the server, and it is assumed that the application is used in an online environment.

Meanwhile, a technology of restricting the usage of contents based on license information is disclosed (see, for example, Patent Document 1).

Patent Document 1: Japanese Laid-Open Patent Publication No. 2006-18552

### SUMMARY

According to an aspect of the embodiments, a license number management system includes a processor configured to execute a process including performing a login process according to first authentication or second authentication, the first authentication being performed for allowing usage of a service in both an online status and an offline status, and the second authentication being performed for allowing usage of the service only in the online status and not in the offline status, and performing license management in a case of authenticating a terminal according to the first authentication by updating license management information to a used state in response to transmission of data needed for using the service to the terminal and updating the license management information to a not used state in response to reception of the data or updated data obtained by updating the data from the terminal, and performing license management in a case of authenticating the terminal according to the second authentication by updating the license management information to a used state in response to the terminal being successfully authenticated and updating the license management information to a not used state in response to logout of the terminal.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an example of a system configuration according to an embodiment;

FIG. 2 illustrates an example of a software configuration of a server;

FIGS. 3A through 3D illustrate examples of data structures of a database;

FIG. 4 illustrates an example of a hardware configuration of the server and a PC client;

FIG. 5 illustrates an example of a hardware configuration of a tablet;

FIG. 6 is a sequence diagram illustrating an example of an application download process;

FIG. 7 illustrates an example of a login process by the PC client (part 1);

FIG. 8 illustrates an example of a login process by the PC client (part 2);

FIG. 9 illustrates an example of a login process by the PC client (part 3);

FIG. 10 illustrates an example of a logout process by the PC client;

FIG. 11 is a sequence diagram illustrating an example of a login process by the tablet;

FIG. 12 illustrates an example of a data checkout process by the tablet (part 1);

FIG. 13 illustrates an example of a data checkout process by the tablet (part 2);

FIG. 14 illustrates an example of a data checkout process by the tablet (part 3);

FIG. 15 illustrates an example of a screen for confirming the data that has been checked out at the tablet;

FIG. 16 illustrates an example of a data checkin process by the tablet (part 1);

FIG. 17 illustrates an example of a data checkin process by the tablet (part 2); and

FIG. 18 is a sequence diagram illustrating an example of a logout process by the tablet.

### DESCRIPTION OF EMBODIMENTS

A concurrent license is preferably used with respect to an application that is used for a particular purpose in a company, etc.; however, there are applications that are not always used in an online environment, and there are cases where it is not possible to manage the concurrent license. For example, in a system of supporting the examination operation at a construction site, etc., by using a tablet (tablet terminal), the input and output of data between the tablet and the server are performed in an online environment, while the application is often used in an offline environment. Therefore, it is not possible to confirm the usage state of the application in an offline environment, and management of the concurrent license is not possible. Note that for an application used in this type of system, the examination data (map, specification, work check list, etc.) is downloaded, and the examination data (updated data), in which the examination results are input, is uploaded, in an offline environment.

Preferred embodiments of the present invention will be explained with reference to accompanying drawings.

### <Configuration>

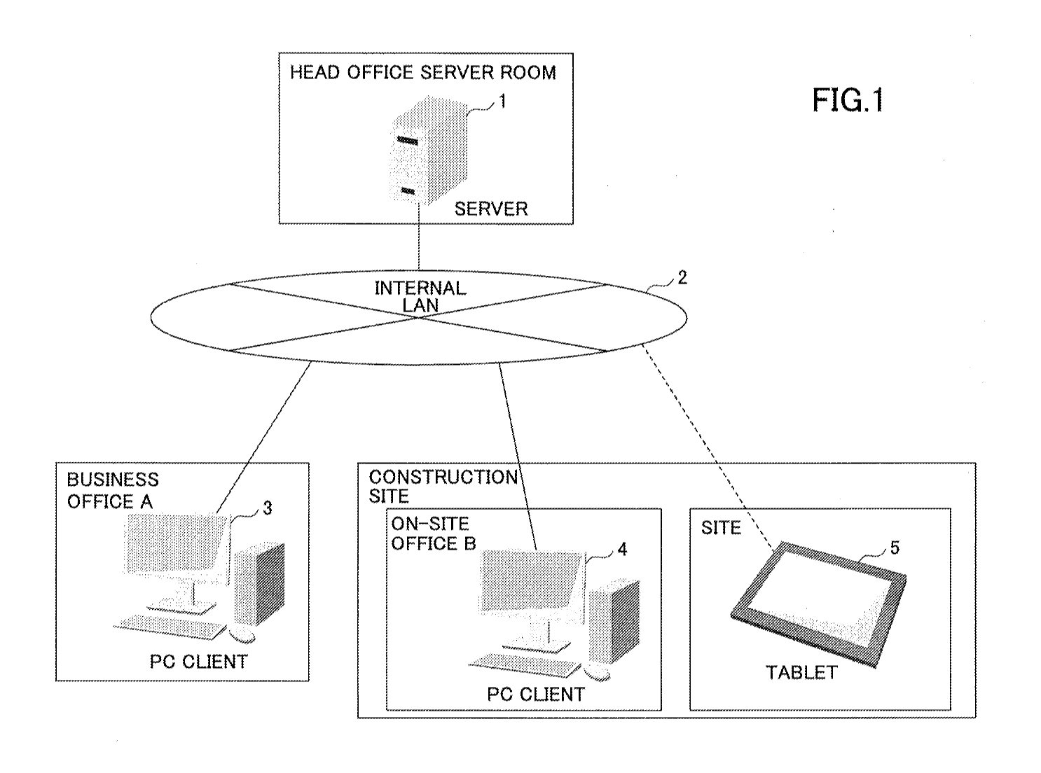

FIG. 1 illustrates an example of a system configuration according to an embodiment. In FIG. 1, a server 1 provided in a head office server room, a PC (Personal Computer) client 3 provided in a business office A, and a PC client 4 provided in an on-site office B at a construction site are able to communicate with each other via an internal LAN (Local Area Network) 2. Furthermore, a tablet 5 provided at a site is able to communicate with the server 1 via the internal LAN 2 when the tablet 5 is positioned inside the on-site office B (online environment); however, when the tablet 5 is positioned at locations in the construction site other than the on-site office B (offline environment), the tablet 5 is unable to communicate with the server 1.

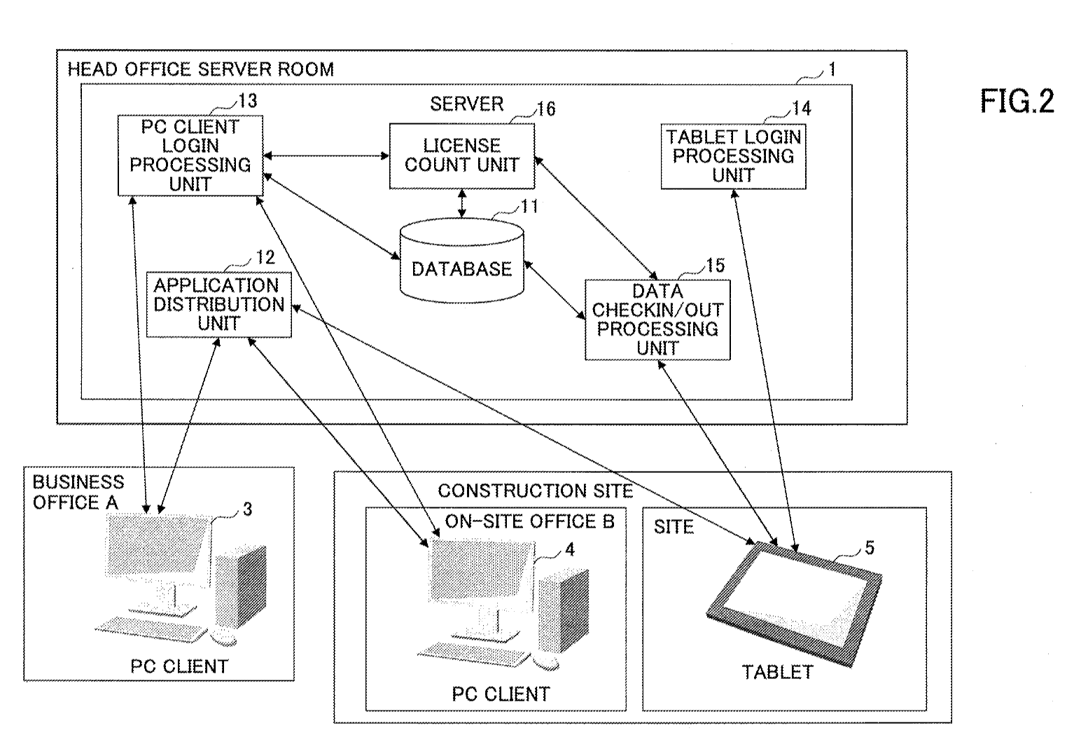

FIG. 2 illustrates an example of a software configuration of the server 1. In FIG. 2, the server 1 includes a database 11, an application distribution unit 12, a PC client login processing unit 13, a tablet login processing unit 14, a data checkin/out processing unit 15, and a license count unit 16.

The database 11 is for holding data to be referred to and updated, when a process is performed at the server 1. An example of the data structure of the database 11 is described below. Note that the database 11 may be managed by a database server etc., other than the server 1.

The application distribution unit 12 has a function of providing an application in response to a request from the PC client 3, 4, and the tablet 5. The application provided to the PC client 3, 4 has a function of implementing overall management, such as creating data for an examination, confirming the examination results, etc. The application provided to the tablet 5 has a function of acquiring data used for the examination from the server 1 (checkout, take out), adding the examination result to the data at the site, and returning the updated data to the server 1 (checkin).

The PC client login processing unit 13 has a function of accepting a login request and a logout request from the application of the PC client 3, 4, and performing a login process and a logout process. Note that the PC client login processing unit 13 cooperates with the license count unit 16, to manage the license number (number of licenses used) with respect to the PC client 3, 4, by setting the period between login to logout by the application as the usage period of the application.

The tablet login processing unit 14 has a function of accepting a login request and a logout request from the application of the tablet 5, and performing a login process and a logout process. Note that the tablet login processing unit 14 does not connect the login and logout by the application of the tablet 5, with the management of the license number.

The data checkin/out processing unit 15 has a function of accepting checkout (take out) and checkin (return) of data, in response to a request from the tablet 5. The data that is checked out is checked in as data in which the examination result, etc., has been input (updated data).

The license count unit 16 has a function of managing the license number of the application, in response to a request, from the PC client login processing unit 13 and the data checkin/out processing unit 15.

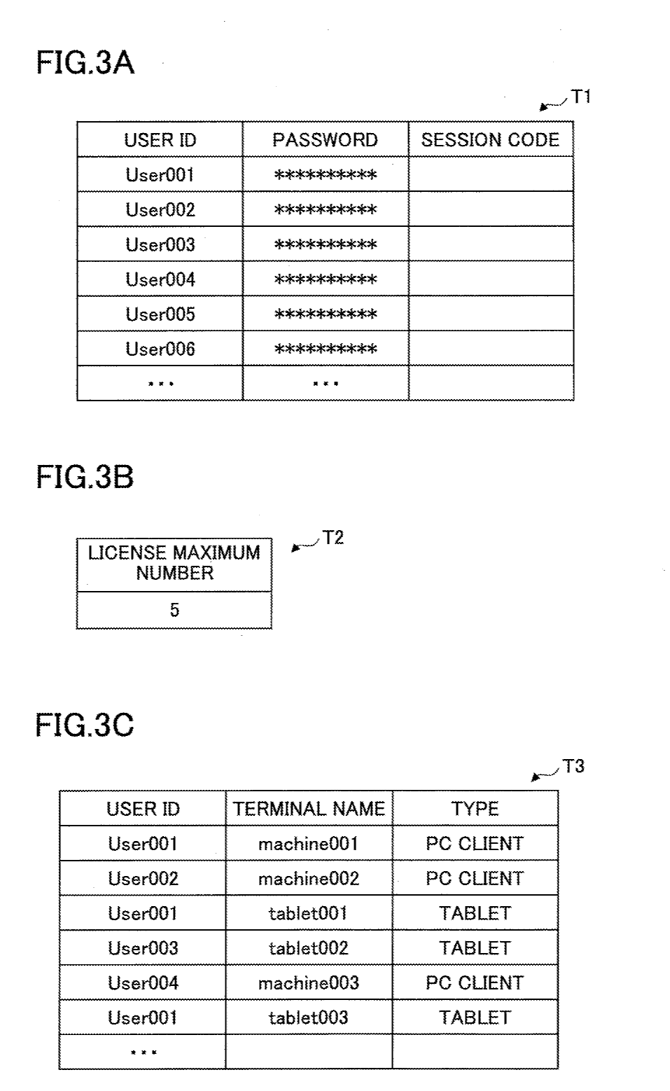

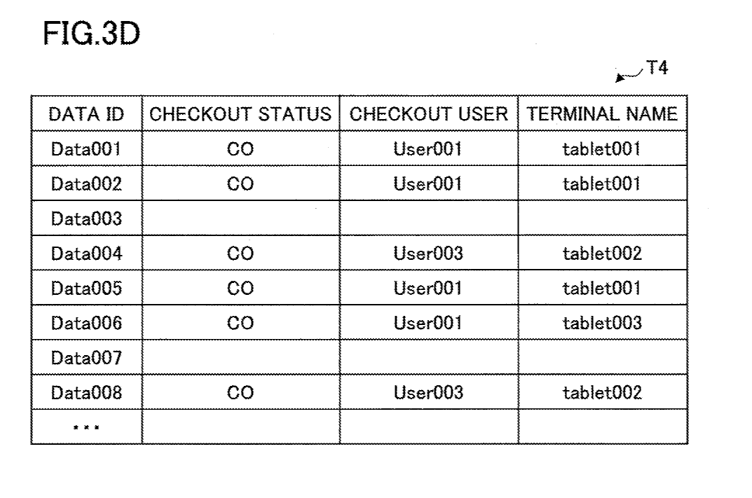

FIGS. 3A through 3D illustrate examples of data structures of the database 11, which respectively illustrate an authentication table T1, a usable license number table T2, a license number count table T3, and a checkin/checkout data table T4.

The authentication table T1 is a table used for an authentication process at the time of login, and includes items such as “user id”, “password”, “session code”, etc. The “user id” is information for identifying the user. The “password” is secret information for confirming the identity of the user. The “session code” is information issued when the user is successfully authenticated and the user has logged in, and the “session code” is deleted when the user logs out.

The usable license number table T2 holds a license maximum number with respect to the application for the PC client and the application for the tablet. As illustrated in FIG. 3B, when the license maximum number is “5”, a total of ten devices, including 5 PC clients and 5 tablets, are able to use the application. Note that a license maximum number may be separately set for an application for the PC client and an application for the tablet.

The license number count table T3 is a table for managing the target that is determined as using the application at the present time point, and includes items such as “user ID”, “terminal name”, “type”, etc. The “user ID” is information for identifying the user. The “terminal name” is the name of the terminal used by the user. The “type” is information indicating the type of the terminal (PC client or tablet). The number of records for each of the PC client and the tablet in the “type” in the license number count table T3, corresponds to the license number at the present time point for the respective applications.

The checkin/checkout data table T4 is a table for managing the state of checkout and checkin by a tablet for each data item, and includes the items of “data ID”, “checkout status”, “checkout user”, “terminal name”, etc. The “data ID” is information for identifying the data. The “checkout status” is information for indicating whether the data is checked out (CO: presently checked out). The “checkout user” is the user ID of the user who is checking out the data. The “terminal name” is the name of the terminal that is checking out the data.

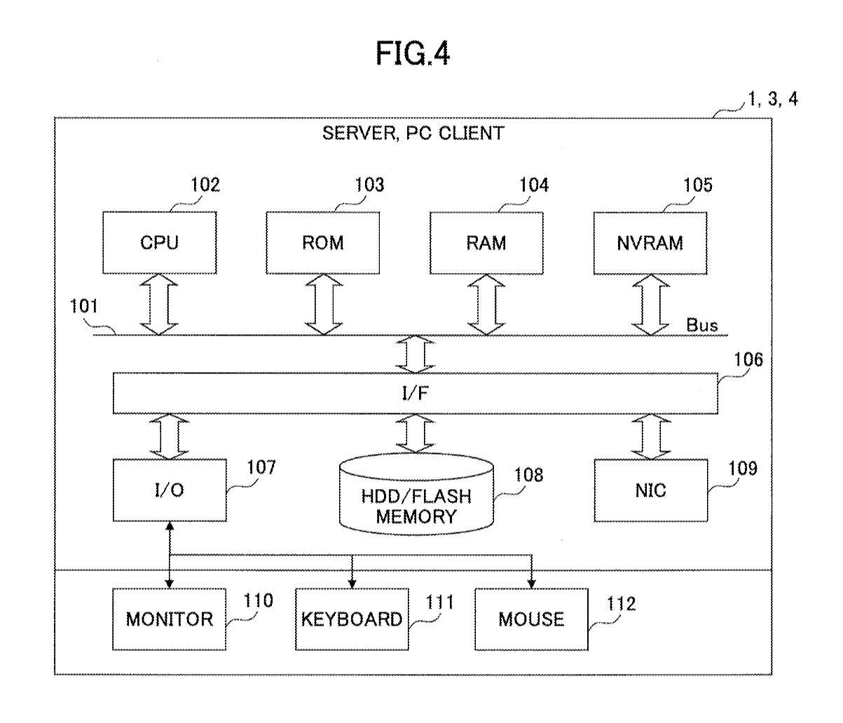

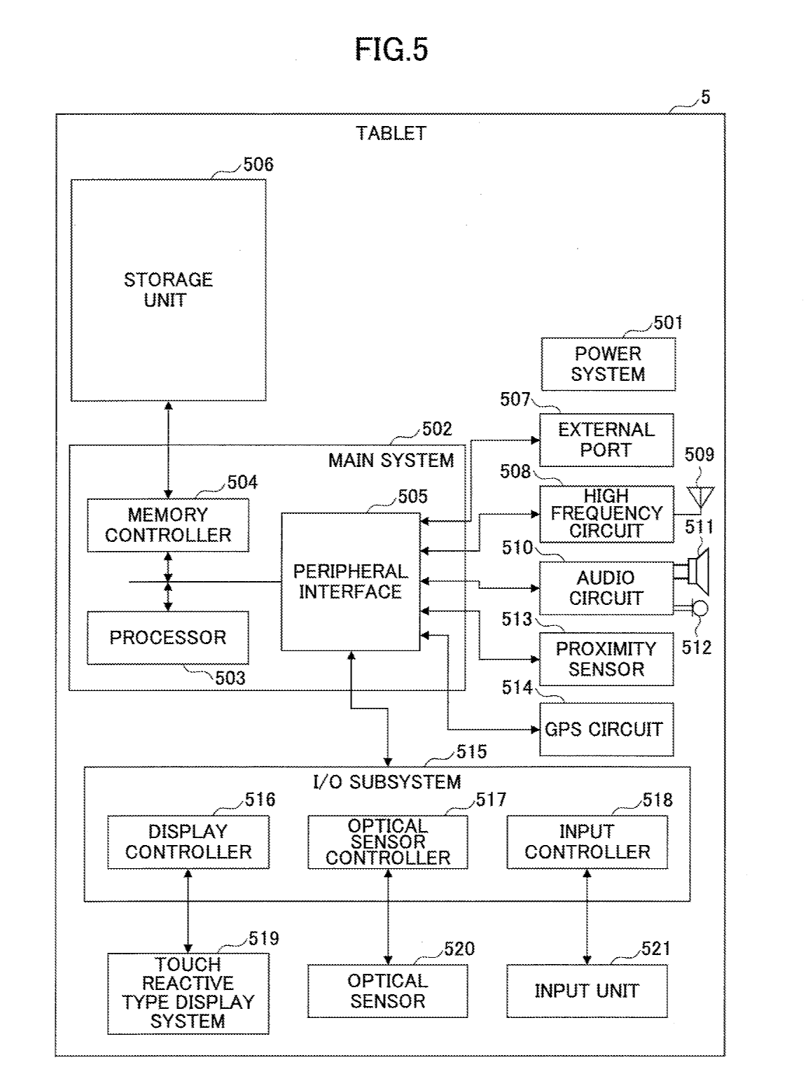

FIG. 4 illustrates an example of a hardware configuration of the server 1, and the PC client 3, 4. In FIG. 4, the server 1, etc., includes a CPU (Central Processing Unit) 102, a ROM (Read Only Memory) 103, a RAM (Random Access Memory) 104, and an NVRAM (Non-Volatile Random Access Memory) 105, which are connected to a system bus 101. Furthermore, the server 1, etc., includes an I/F (Interface) 106; an I/O (Input/Output Device) 107, a HDD (Hard Disk Drive)/flash memory 108, and a MIC (Network Interface Card) 109, connected to the I/F 106; and a monitor 110, a keyboard 111, and a mouse 112 connected to the I/O 107. A CD/DVD (Compact Disk/Digital Versatile Disk) drive, etc., may be connected to the I/O 107. The units 12 through 15 of the server 1 in FIG. 2 are realized by executing predetermined programs in the CPU 102. The program may be provided by a recording medium, or may be provided via a network.

FIG. 5 illustrates an example of a hardware configuration of the tablet 5. In FIG. 5, the tablet 5 includes a power system 501; a main system 502 including a processor 503, a memory controller 504, and a peripheral interface 505; and a storage unit 506. Furthermore, the tablet 5 includes an external port 507, a high frequency circuit 508, an antenna 509, an audio circuit 510, a speaker 511, a microphone 512, a proximity sensor 513, and a GPS (Global Positioning System) circuit 514. Furthermore, the tablet 5 includes an I/O (Input/Output) subsystem 515 including a display controller 516, an optical sensor controller 517, and an input controller 518; a touch reactive type display system 519; an optical sensor 520; and an input unit 521.

### <Application Download Process>

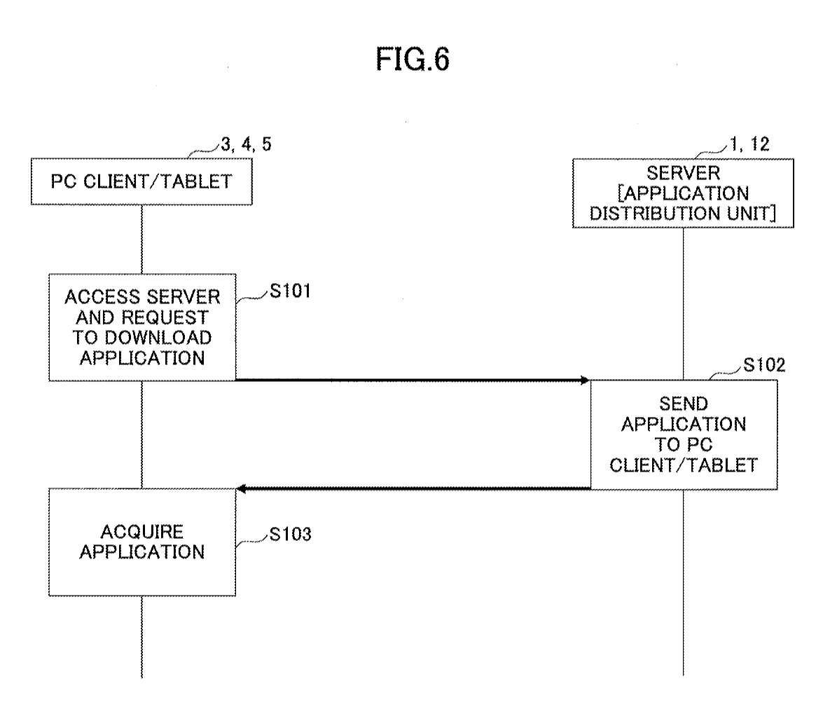

FIG. 6 is a sequence diagram illustrating an example of an application download process. In FIG. 6, when the PC client 3, 4, or the tablet 5 accesses the server 1 and requests the download of the application (step S101), the application distribution unit 12 of the server 1 sends the corresponding application to the request source (step S102). Accordingly, the PC client 3, 4 or the tablet 5 acquires the application (step S103).

Note that when the PC client 3, 4 or the tablet 5 accesses the server 1, a user ID and a password may accompany the access, and the application may be sent only when the authentication is successful.

### <Login Process of PC Client>

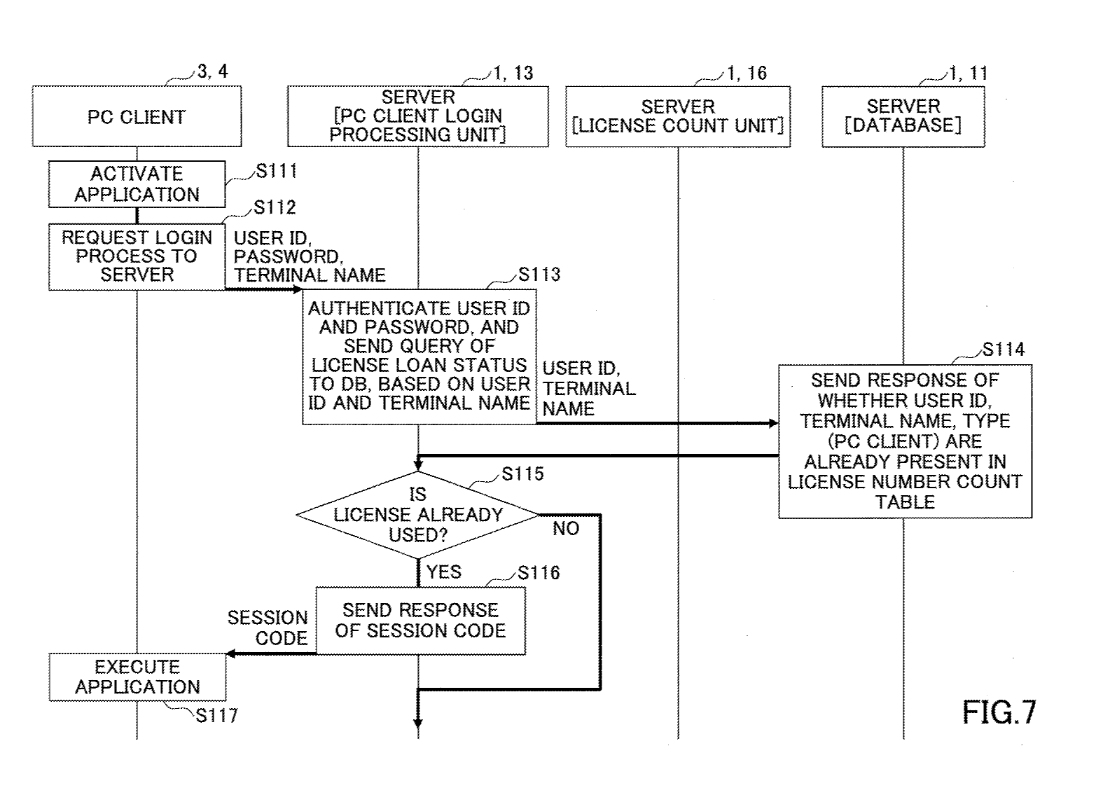

FIGS. 7 through 9 illustrate an example of a login process by the PC client 3, 4. In FIG. 7, when the application is activated in the PC client 3, 4 (step S111), a request for a login process is sent from the application to the server 1, together with a user ID, a password, and a terminal name (step S112).

The PC client login processing unit 13 or the server 1 performs authentication based on the authentication table T1 from the user ID and the password, and when the authentication is successful, the PC client login processing unit 13 sends a query of the license loan status to the database 11 based on the user ID and the terminal name (step S113).

The database 11 confirms whether the user ID, the terminal name, and the type (PC client because the request is from the PC client login processing unit 13) are already present in the license number count table T3, and sends a response (step S114).

The PC client login processing unit 13 determines whether the PC client 3, 4 that has made the request is already using the license of the application, from the response result from the database 11 (step S115). When the PC client login processing unit 13 determines that the license is already used (YES in step S115), the PC client login processing unit 13 generates a session code and sends a response of the session code to the PC client 3, 4 (step S116). Accordingly, the PC client 3, 4 executes the application (step S117).

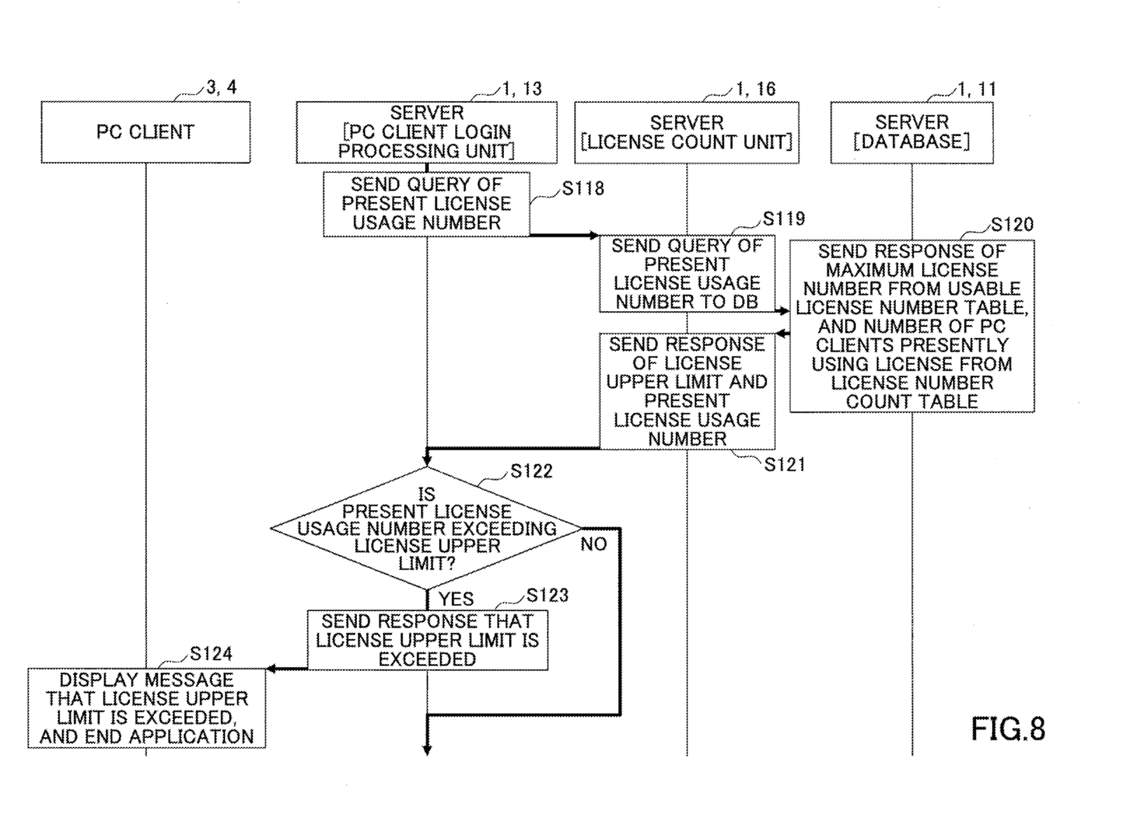

Furthermore, when the PC client login processing unit 13 determines that the license is not used (NO in step S115), with reference to FIG. 8, the PC client login processing unit 13 sends a query of the present license usage number to the license count unit 16 (step S118), and the license count unit 16 sends a query of the present license usage number to the database 11 (step S119).

The database 11 acquires the maximum license number from the usable license number table T2 acquires the number of PC clients presently using the license from the license number count table T3, and sends a response to the license count unit 16 (step S120). The license count unit 16 sends a response of the license upper limit (maximum license number) and the usage number (number of PC clients presently using the license) to the PC client login processing unit 13 (step S121).

The PC client login processing unit 13 determines whether the present usage number is exceeding the license upper limit, from the response result from the license count unit 16 (step S122). When the PC client login processing unit 13 determines that the present usage number is exceeding the license upper limit (YES in step S122), the PC client login processing unit 13 sends a response that the license upper limit is exceeded to the PC client 3, 4 (step S123), and the application of the PC client 3, 4 displays a message that the license upper limit is exceeded and ends the application (step S124).

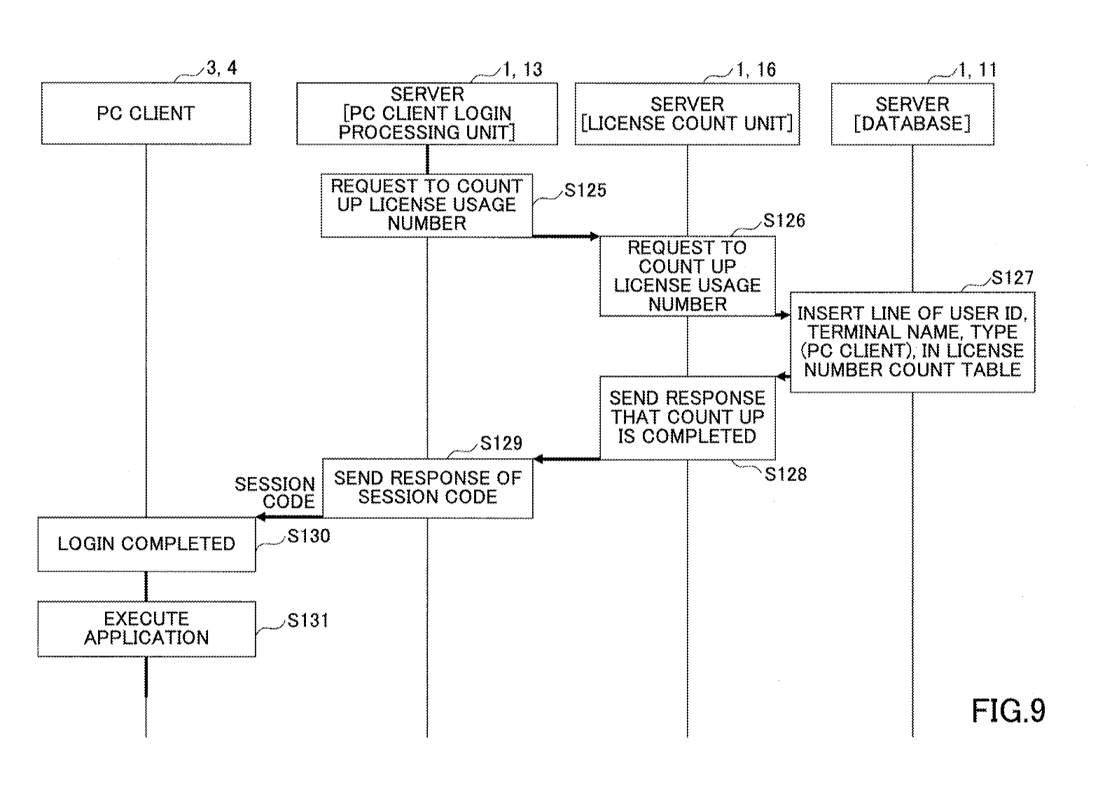

Furthermore, when the PC client login processing unit 13 determines that the license upper limit is not exceeded (NO in step S122), with reference to FIG. 9, the PC client login processing unit 13 sends a request to count up the license usage number to the license count unit 16 (step S125), and the license count unit 16 sends a request to count up the license usage number to the database 11 (step S126).

The database 11 inserts an line of the user ID, the terminal name, and the type (PC client) in the license number count table T3, and sends a response of completion to the license count unit 16 (step S127). That is, the database 11 updates the management information of the license (license management information) to a used state. The license count unit 16 sends a response that the count up is completed, to the PC client login processing unit 13 (step S128).

Upon receiving the response, the PC client login processing unit 13 generates a session code and sends a response or the session code to the PC client 3, 4 (step S129). The PC client 3, 4 completes login (step S130), and executes the application (step S131).

As described above, with respect to the application of the PC client 3, 4, the license number is counted up as a part of the login process.

### <Logout Process of PC Client>

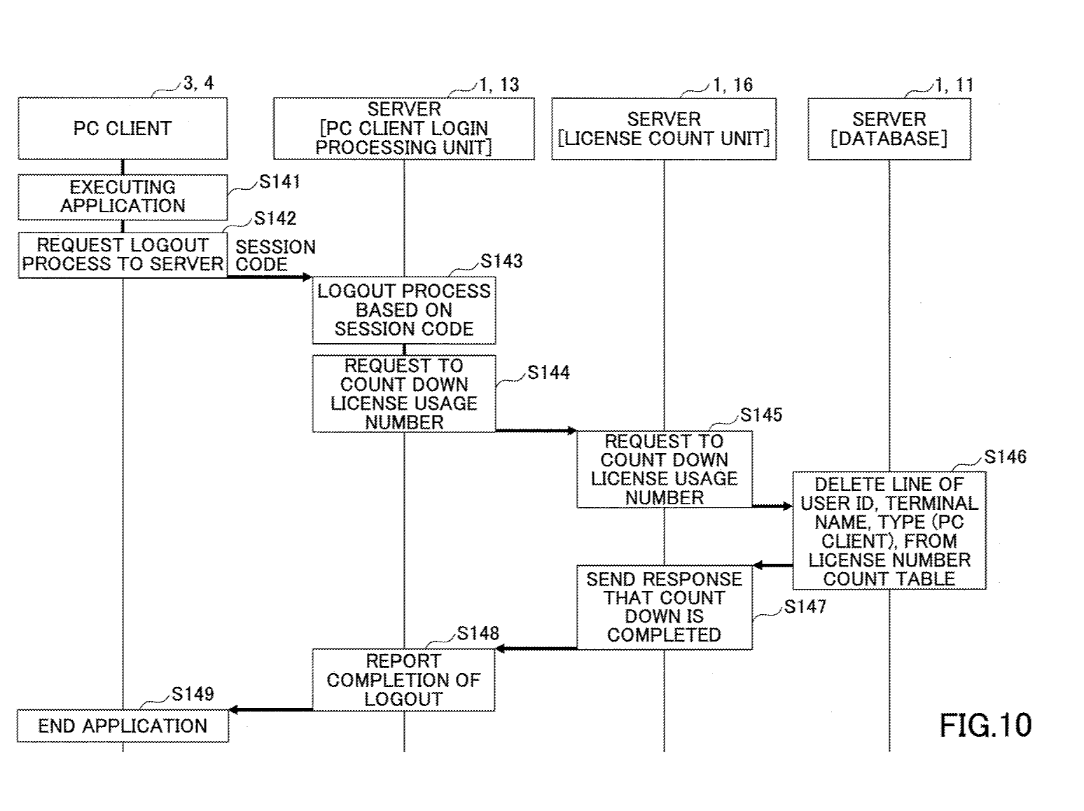

FIG. 10 illustrates an example of a logout process by the PC client 3, 4. In FIG. 10, while the application is being executed at the PC client 3, 4 (step S141), a logout process is requested from the application to the server 1 together with a session code (step S142), and the PC client login processing unit 13 performs a logout process based on the session code (delete session code, etc.) (step S143).

Next, the PC client login processing unit 13 requests the license count unit 16 to count down the license usage number (step S144), and the license count unit 16 requests the database 11 to count down the license usage number (step S145).

The database 11 deletes the line of the user ID, the terminal name, and the type (PC client) from the license number count table T3, and sends a response of completion to the license count unit 16 (step S146). That is, the database 11 updates the management information of the license (license management information) to an unused state. The license count unit 16 sends a response that the countdown is completed, to the PC client login processing unit 13 (step S147).

Upon receiving the response, the PC client login processing unit 13 reports the logout completion to the PC client 3, 4 (step S148), and the PC client 3, 4 ends the application (S149).

As described above, with respect to the application of the PC client 3, 4, the license number is counted down as a part of the logout process.

### <Login Process of Tablet>

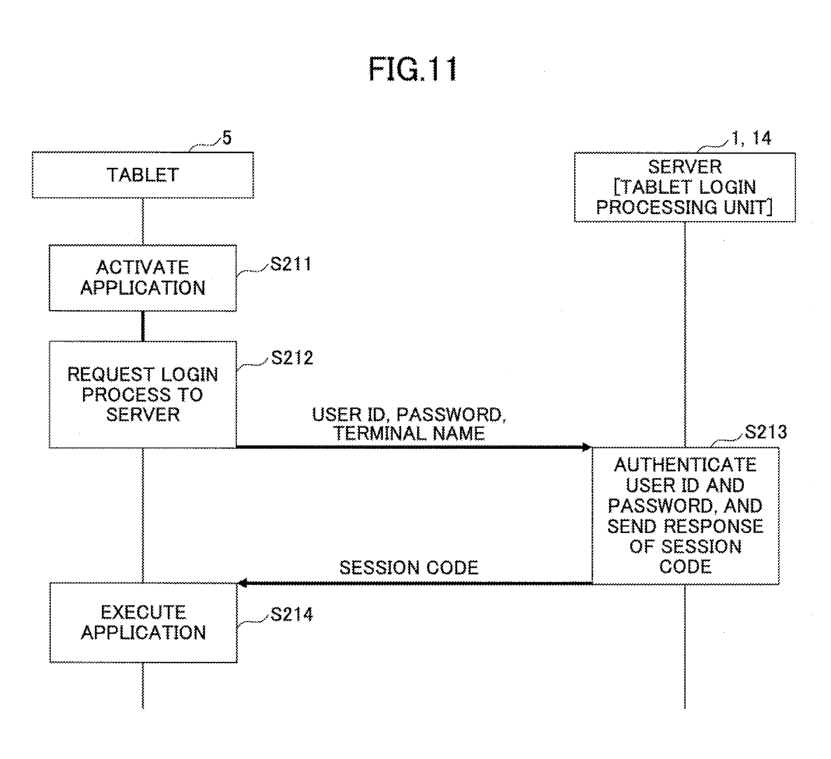

FIG. 11 is a sequence diagram illustrating an example of a login process by the tablet 5. In FIG. 11, when the application is activated in the tablet 5 (step S211), the application sends a request for a login process to the server 1, together with a user ID, a password, and a terminal name (step S212).

The PC tablet login processing unit 14 of the server 1 performs authentication based on the authentication table T1 from the user ID and the password, and when the authentication is successful, the tablet login processing unit 14 generates a session code and sends a response of the session code to the tablet 5 (step S213). Accordingly, the tablet 5 executes the application (step S214).

### <Data Checkout Process of Tablet>

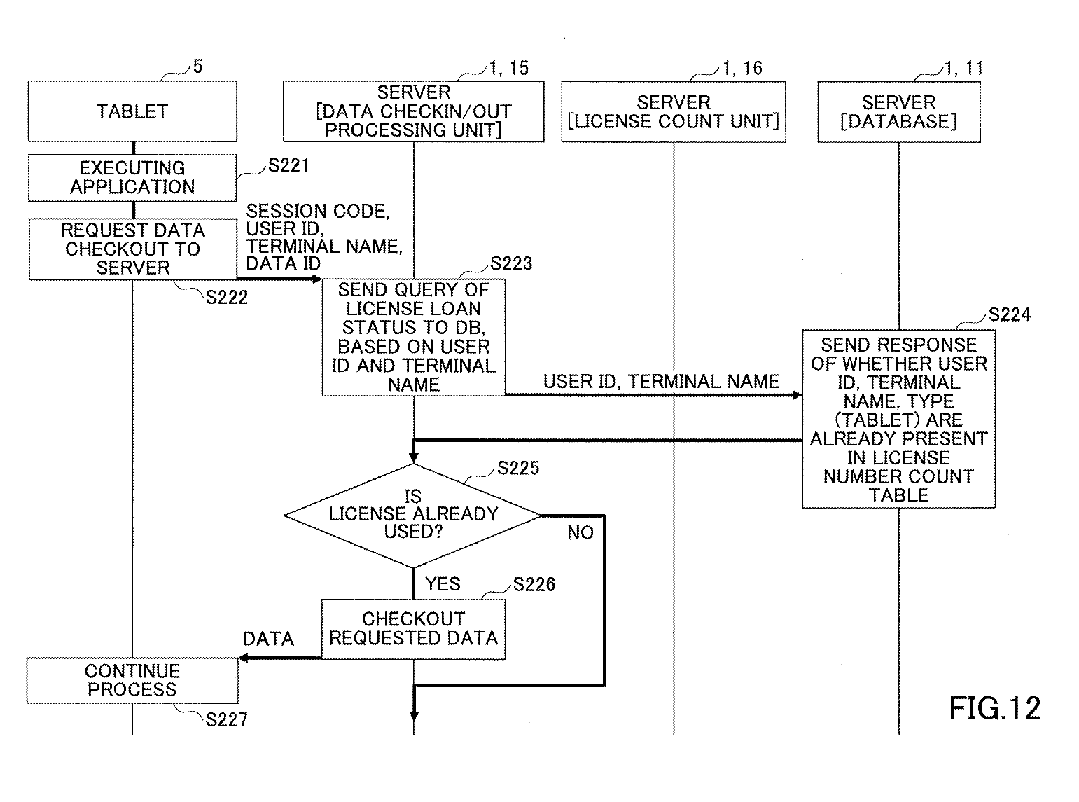

FIGS. 12 through 14 illustrate an example of a data checkout process by the tablet 5. In FIG. 12, when acquiring data used for an examination at the tablet 5, while the application is being executed (step S221), a request for data checkout is sent from the application to the server 1, together with a session code, a user ID, a terminal name, and a data ID (step S222).

When the data checkin/out processing unit 15 of the server 1 confirms that the tablet 5 has already logged in from the session code, the data checkin/out processing unit 15 sends a query of the license loan status to the database 11 based on the user ID and the terminal name (step S223).

The database 11 confirms whether the user ID, the terminal name, and the type (tablet because the request is from the data checkin/out processing unit 15) are already present in the license number count table T3, and sends a response (step S224).

The data checkin/out processing unit 15 determines whether the tablet 5 that has made the request is already using the license of the application, from the response result from the database 11 (step S225). When the data checkin/out processing unit 15 determines that the license is already used (YES in step S225), the data checkin/out processing unit 15 makes a checkout registration to the checkin/checkout data table T4 with respect to the requested data, and sends the data to the tablet 5 (step S226). The application of the tablet 5 acquires the data and continues the process (step S227).

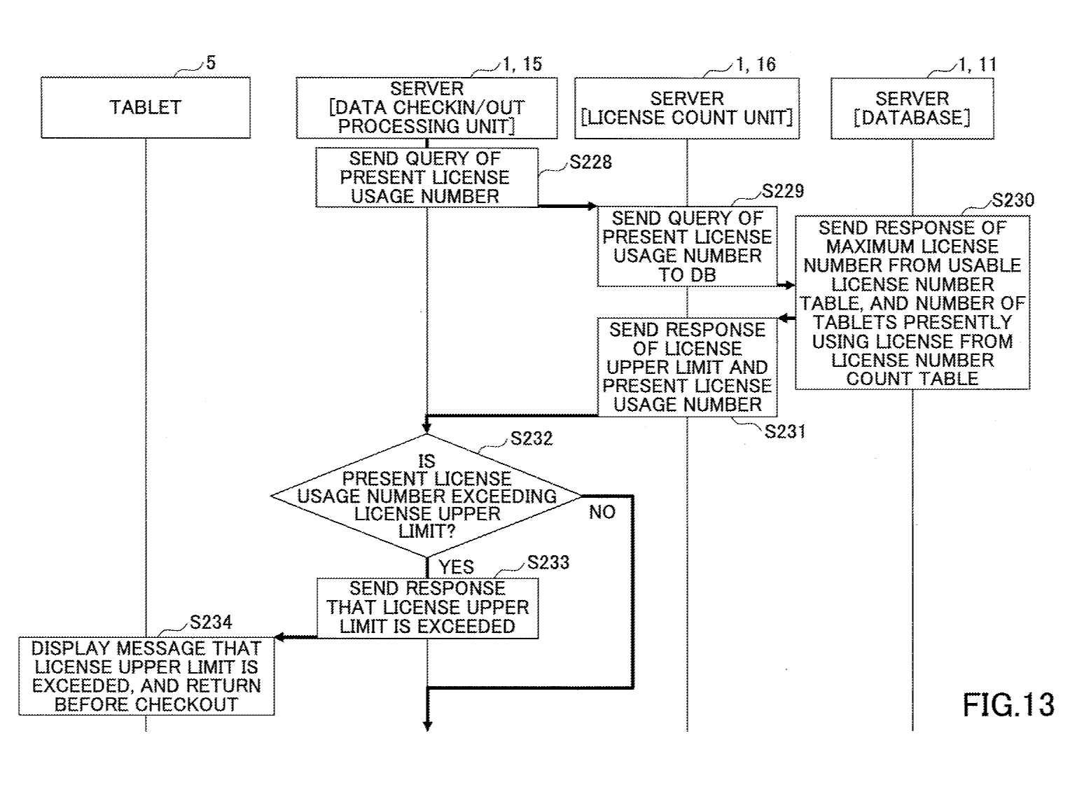

Furthermore, when the data checkin/out processing unit 15 determines that the license is not used (NO in step S225), with reference to FIG. 13, the data checkin/out processing unit 15 sends a query of the present license usage number to the license count unit 16 (step S228), and the license count unit 16 sends a query of the present license usage number to the database 11 (step S229).

The database 11 acquires the maximum license number from the usable license number table T2, acquires the number of tablets presently using the license from the license number count table T3, and sends a response to the license count unit 16 (step S230). The license count unit 16 sends a response of the license upper limit (maximum license number) and the usage number (number of tablets presently using the license) to the data checkin/out processing unit 15 (step S231).

The data checkin/out processing unit 15 determines whether the present usage number is exceeding the license upper limit, from the response result from the license count unit 16 (step S232). When the data checkin/out processing unit 15 determines that the present usage number is exceeding the license upper limit (YES in step S232), the data checkin/out processing unit 15 sends a response that the license upper limit is exceeded to the tablet 5 (step S233), and the application of the tablet 5 displays a message that the license upper limit is exceeded and returns to the state before the data checkout (step S234).

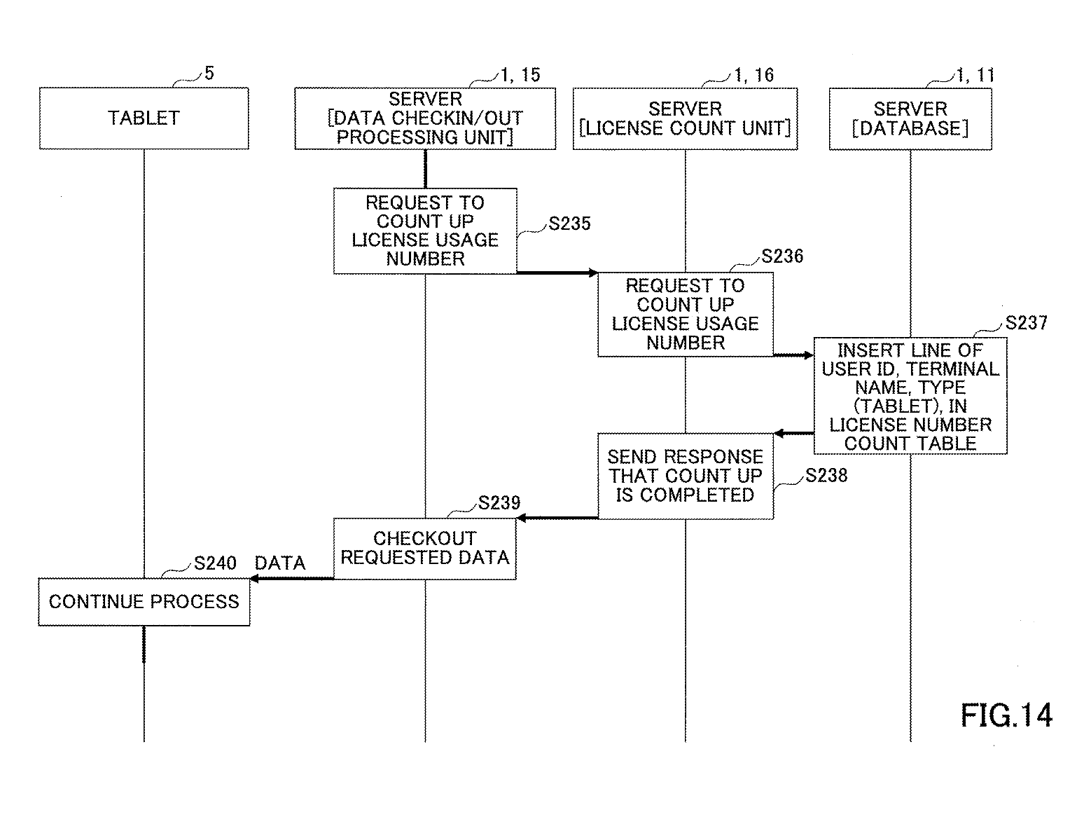

Furthermore, when the data checkin/out processing unit 15 determines that the license upper limit is not exceeded (NO in step S232), with reference to FIG. 14, the data checkin/out processing unit 15 sends a request to count up the license usage number to the license count unit 16 (step S235), and the license count unit 16 sends a request to count up the license usage number to the database 11 (step S236).

The database 11 inserts an line of the user ID, the terminal name, and the type (tablet) in the license number count table T3, and sends a response of completion to the license count unit 16 (step S237). That is, the database 11 updates the management information of the license (license management information) to a used state. The license count unit 16 sends a response that the count up is completed, to the data checkin/out processing unit 15 (step S238).

Upon receiving the response, the data checkin/out processing unit 15 makes a checkout registration to the checkin/checkout data table T4 with respect to the requested data, and sends the data to the tablet 5 (step S239). The application of the tablet 5 continues the process (step S240).

As described above, with respect to the application of the tablet 5, the license number is counted up as a part of the data checkout.

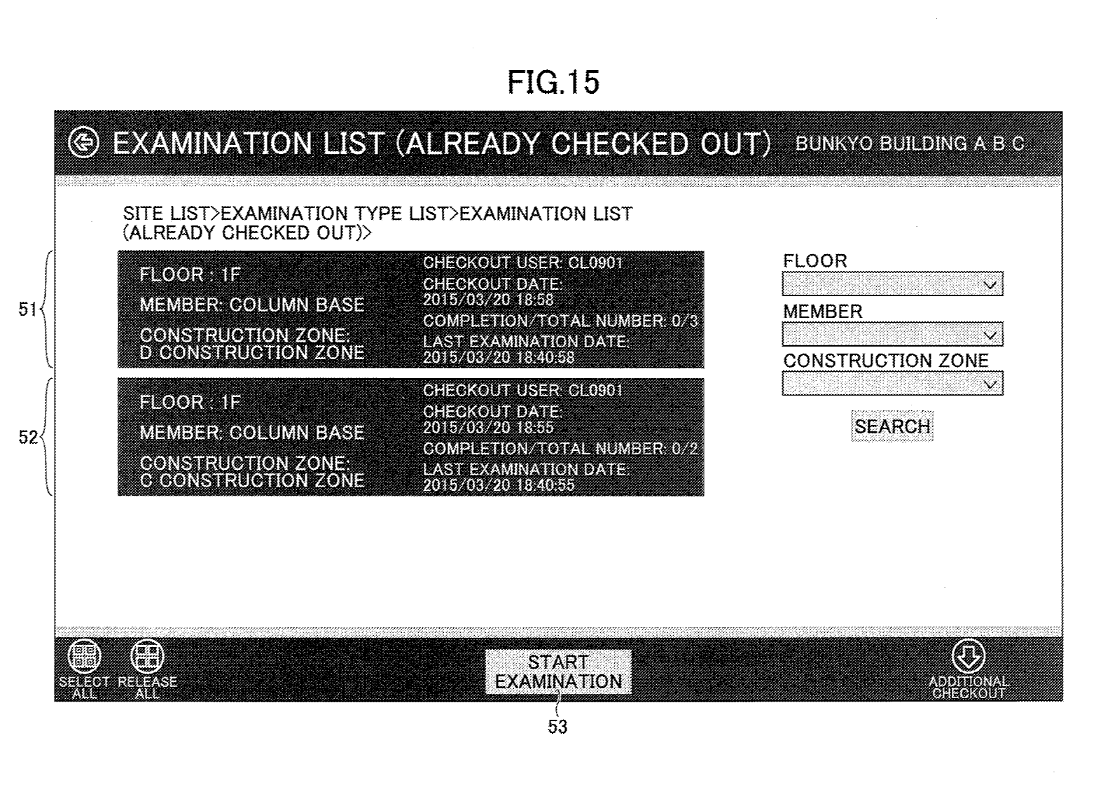

FIG. 15 illustrates an example of a screen for confirming the data that has been checked out, at the tablet 5. In FIG. 15, in the screen of the tablet, display fields 51, 52 are displayed in units of data, and by selecting the data of the desired display field and pressing the start examination button 53, the screen transitions to a screen for displaying the examination procedures, etc., and a screen for inputting examination results.

### <Data Checkin Process of Tablet>

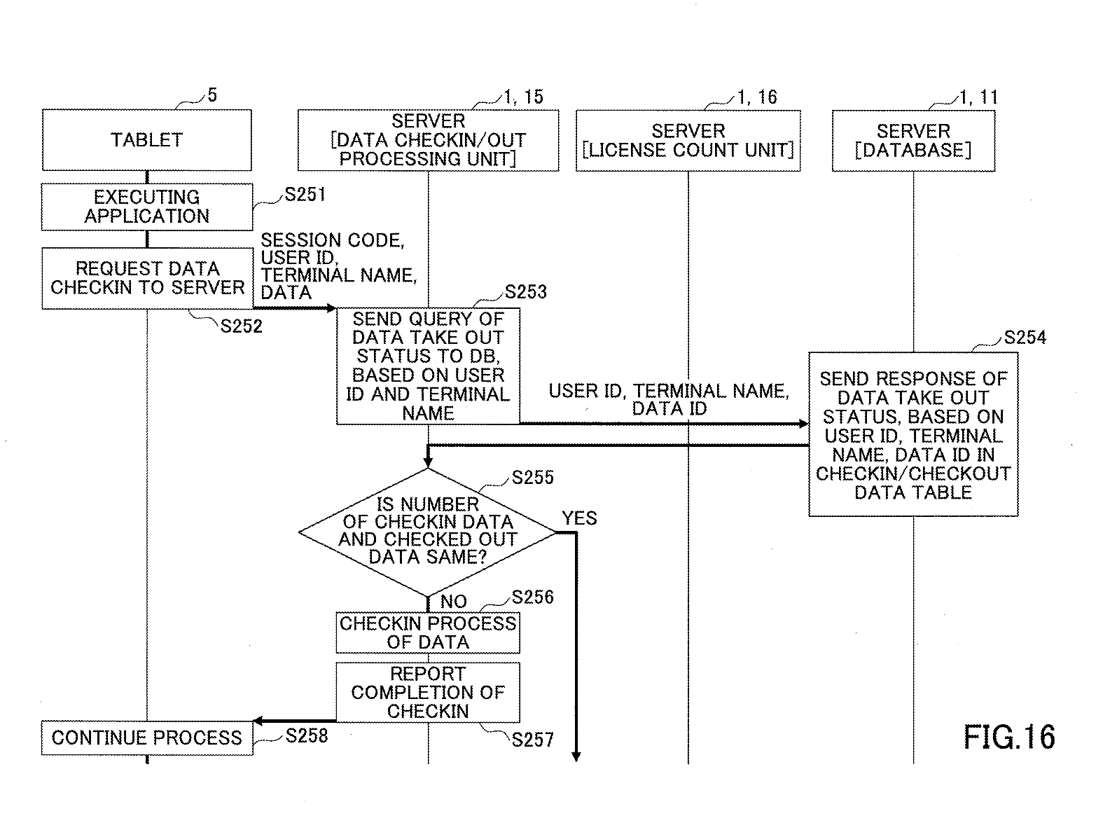

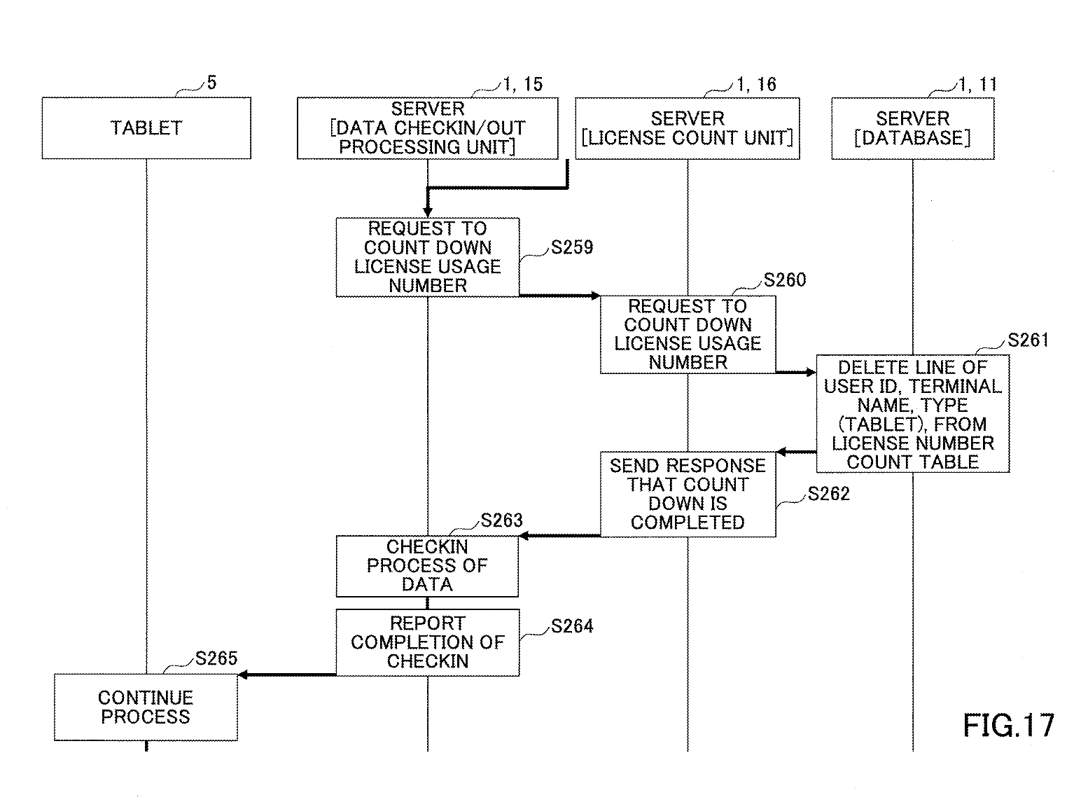

FIGS. 16 and 17 illustrate an example of a data checkin process by the tablet 5. In FIG. 16, when returning data (updated data) in which the examination result has been input at the tablet 5, while the application is being executed (step S251), a request for data checkin is sent from the application to the server 1, together with a session code, a user ID, a terminal name, and the data (updated data) (step S252).

When the data checkin/out processing unit 15 of the server 1 confirms that the tablet 5 has already logged in from the session code, the data checkin/out processing unit 15 sends a query of the data take out status to the database 11 based on the user ID, the terminal name, and the data ID (step S253).

The database 11 confirms the data take out status based on the user ID, the terminal name, and the data ID in the checkin/checkout data table T4, and sends a response (step S254).

The data checkin/out processing unit 15 determines whether the number of data items and the contents of the data items (specified by data IDs) of the checkin data are the same as those of the checked out data (step S255). When the data checkin/out processing unit 15 determines that the number and the contents of the checkin data and those of the checked out data are not the same (NO in step S255), the data checkin/out processing unit 15 performs a checkin process of the data (update the checkin/checkout data table T4, save the updated data, etc.) (step S256), and reports the checkin completion to the tablet 5 (step S257). The application of the tablet 5 continues the process (step S258).

When the data checkin/out processing unit 15 determines that the number and the contents of the checkin data and the checked out data are the same (YES in step S255), with reference to FIG. 17, the data checkin/out processing unit 15 requests the license count, unit 16 to count down the license usage number (step S259), and the license count unit 16 requests the database 11 to count down the license usage number (step S260).

The database 11 deletes the line of the user ID, the terminal name, and the type (tablet) from the license number count table T3, and sends a response of completion to the license count unit 16 (step S261). That is, the database 11 updates the management information of the license (license management information) to an unused state. The license count unit 16 sends a response that the countdown is completed, to the data checkin/out processing unit 15 (step S262).

Upon receiving the response, the data checkin/out processing unit 15 performs the checkin process of the data (update the checkin/checkout data table T4, save the updated data, etc.) (step S263), and reports the data checkin completion to the tablet 5 (step S264). The application of the tablet 5 continues the process (step S265).

As described above, with respect to the application of the tablet 5, the license number is counted down by checking in all of the data that has been checked out.

### <Logout Process of Tablet>

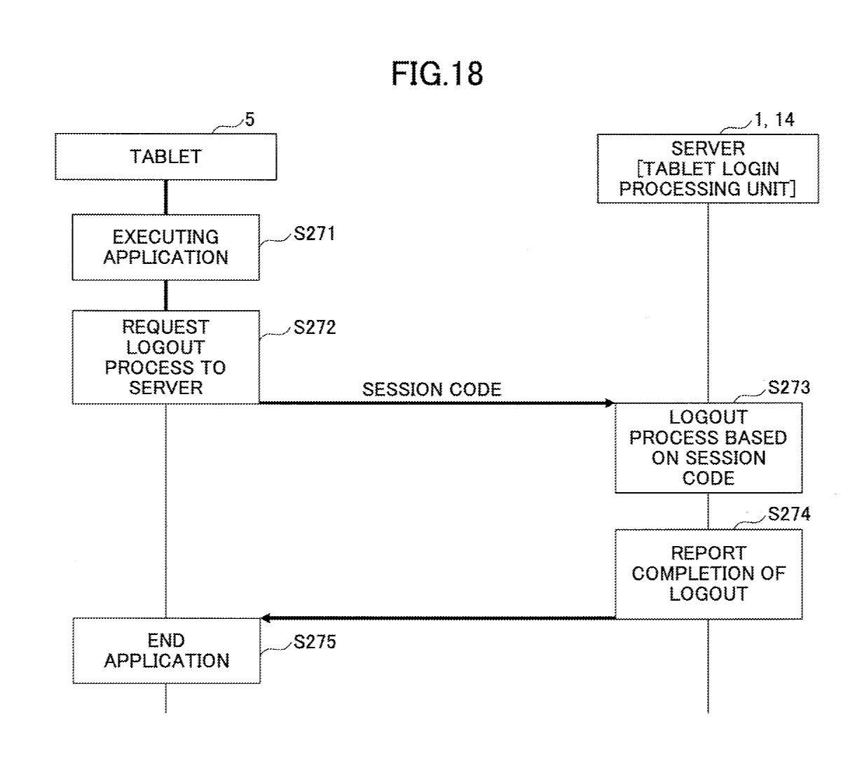

FIG. 18 is a sequence diagram illustrating an example of a logout process by the tablet 5. In FIG. 18, while the application is being executed at the tablet 5 (step S271), a logout process is requested from the application to the server 1 together with a session code (step S272), and the tablet login processing unit 14 performs a logout process based on the session code (delete session code, etc.) (step S273).

Next, the tablet login processing unit 14 reports the logout completion to the tablet 5 (step S274), and the tablet 5 ends the application (S275).

Note that in the present embodiment, a description is given of an example of realizing the management of the number of licenses being used, by counting up the number of licenses being used. However, the management method is not so limited, as long as the number of licenses being used is managed so as not to exceed the maximum number of licenses. For example, the number of licenses being used may be managed so as not to exceed the maximum number of licenses, by counting down the remaining number of usable licenses every time usage of a license is allowed.

### <Overview>

As described above, according to the present embodiment, it is possible to manage, in the same manner as a concurrent license, an application that is mainly used in an offline environment but is used in an online environment when input, and output of data is performed with a server.

The present invention is not limited to the specific embodiments described herein, and variations and modifications may be made without departing from the wide-ranged purpose and the scope of the present invention. That is, the present invention is not to be construed as being limited by the detailed examples or the accompanying drawings.

The tablet login processing unit 14 and the PC client login processing unit 13 are examples of a “login processing unit”. The data checkin/out processing unit 15 is an example of a “transmission unit”. The data checkin/out processing unit 15 is an example of a “reception unit”. The license count unit 16 is an example of a “license management unit”. The database 11 is an example of a “storage unit”. The data checkin/out processing unit 15 is an example of an “accepting unit”.

According to an aspect of the embodiments, a license number management system and a license number management method are provided, which are capable of managing, in the same manner as a concurrent license, an application that is mainly used in an offline environment but is used in an online environment when input and output of data is performed with a server.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A license number management system comprising:
a processor configured to execute a process including
performing a login process according to first authentication or second authentication, the first authentication being performed for allowing usage of a service in both an online status and an offline status, and the second authentication being performed for allowing usage of the service only in the online status and not in the offline status, and
performing license management in a case of authenticating a terminal according to the first authentication by updating license management information to a used state in response to transmission of data needed for using the service to the terminal and updating the license management information to a not used state in response to reception of the data or updated data obtained by updating the data from the terminal, and performing license management in a case of authenticating the terminal according to the second authentication by updating the license management information to a used state in response to the terminal being successfully authenticated and updating the license management information to a not used state in response to logout of the terminal.

2. A license number management system comprising:
a processor configured to execute a process including
accepting, from a terminal, a download request relating to data needed for using a service,
transmitting, to the terminal, the data for which the download request has been accepted, when a number of licenses indicating a used state in license management information stored in a storage unit with respect to the service, does not exceed a predetermined number,
receiving, from the terminal, the data or updated data obtained by updating the data by the terminal, and
performing license management by updating the license management information stored in the storage unit to a used state in response to the transmission of the data to the terminal, and updating the license management information to a not used state in response to the reception of the data from the terminal.

3. The license number management system according to claim 2, wherein
the transmitting includes transmitting a plurality of types of the data to the terminal, and
the performing of the license management includes updating the license management information stored in the storage unit to a used state for a number of the terminals that are transmission destinations, in response to the transmission of the data.

4. The license number management system
according to claim 2, wherein the process further includes
storing, in the storage unit, an identifier of the data to be transmitted and a terminal ID of the terminal or a user ID of a user that is a transmission destination, in association with each other, wherein
the receiving includes receiving the data or the updated data in a state where association with the user ID or the terminal ID is possible, and
the performing of the license management includes updating the license management information to a not used state upon receiving all of the data, which is indicated by the identifier stored in the storage unit in association with the user ID or the terminal ID.

5. A license number management method executed by a computer, comprising:
performing a login process according to first authentication or second authentication, the first authentication being performed for allowing usage of a service in both an online status and an offline status, and the second authentication being performed for allowing usage of the service only in the online status and not in the offline status; and
performing license management in a case of authenticating a terminal according to the first authentication by updating license management, information to a used state in response to transmission of data needed for using the service to the terminal and updating the license management information to a not used state in response to reception of the data or updated data obtained by updating the data from the terminal, and performing license management in a case of authenticating the terminal according to the second authentication by updating the license management information to a used state in response to the terminal being successfully authenticated and updating the license management information to a not used state in response to logout of the terminal.

6. A license number management method executed by a computer, comprising:
accepting, from a terminal, a download request relating to data needed for using a service;
transmitting, to the terminal, the data for which the download request has been accepted, when a number of licenses indicating a used state in license management information stored in a storage unit with respect to the service, does not exceed a predetermined number;
receiving, from the terminal, the data or updated data obtained by updating the data by the terminal; and
performing license management by updating the license management information stored in the storage unit to a used state in response to the transmission of the data to the terminal, and updating the license management information to a not used state in response to the reception of the data from the terminal.

7. The license number management method according to claim 6, wherein
the transmitting includes transmitting a plurality of types of the data to the terminal, and
the performing of the license management includes updating the license management information stored in the storage unit to a used state for a number of the terminals that are transmission destinations, in response to the transmission of the data.

8. The license number management method according to claim 6, further comprising:
storing, in the storage unit, an identifier of the data to be transmitted and a terminal ID of the terminal or a user ID of a user that is a transmission destination, in association with each other, wherein
the receiving includes receiving the data or the updated data in a state where association with the user ID or the terminal ID is possible, and
the performing of the license management includes updating the license management, information to a not used state upon receiving all of the data, which is indicated by the identifier stored in the storage unit in association with the user ID or the terminal ID.
